(19) United States
(12) Patent Application Publication
(10) Pub. No.: US 2026/0051544 A1
(43) Pub. Date: Feb. 19, 2026

(54) LITHIUM SECONDARY BATTERY

(71) Applicant: SK ON CO., LTD., Seoul (KR)

(72) Inventors: Jeong Seok YEON, Daejeon (KR); Hyeon Soo KANG, Daejeon (KR); Jae Ram KIM, Daejeon (KR); Ji Won NA, Daejeon (KR); So Hyun PARK, Daejeon (KR); Sang Won BAE, Daejeon (KR); Ji Hee BAE, Daejeon (KR); Yeon Hwa SONG, Daejeon (KR); Ki Joo EOM, Daejeon (KR); Geon Hee YOON, Daejeon (KR); Myung Ro LEE, Daejeon (KR); Jae Yeong LEE, Daejeon (KR); Hyun Joong JANG, Daejeon (KR); Hye Ju JANG, Daejeon (KR)

(21) Appl. No.: 19/303,396

(22) Filed: Aug. 19, 2025

(30) Foreign Application Priority Data
Aug. 19, 2024 (KR) 10-2024-0110409

(51) Int. Cl. H01M 10/0569; H01M 4/133; H01M 4/134; H01M 4/62

(52) U.S. Cl. CPC H01M 10/0569; H01M 4/133; H01M 4/134; H01M 4/622; H01M 2300/0034

(57) ABSTRACT

A lithium secondary battery according to the present disclosure may comprise a positive electrode; a negative electrode; and an electrolyte comprising a lithium salt, an organic solvent, and an additive, wherein the organic solvent may comprise ethylene carbonate (EC) and propylene carbonate (PC), wherein the additive may comprise fluoroethylene carbonate (FEC), and a volume ratio of the propylene carbonate to the ethylene carbonate in the organic solvent may be 0.2 or more and less than 4.

### CROSS-REFERENCE TO RELATED PATENT APPLICATION

The present application claims priority under 35 U.S.C. § 119(a) to Korean patent application number 10-2024-0110409 filed on Aug. 19, 2024, in the Korean Intellectual Property Office, the entire disclosure of which is incorporated by reference herein.

### BACKGROUND OF THE INVENTION

### 1. Field

The present disclosure relates to a lithium secondary battery.

### 2. Description of the Related Art

Lithium secondary batteries are actively being developed and applied due to their high operating voltage, high energy density per unit weight, fast charging capability, and suitability for lightweight applications. A lithium secondary battery may include an electrode assembly comprising a positive electrode, a negative electrode, and a separator interposed between the positive electrode and the negative electrode, and an electrolyte that impregnates the electrode assembly.

Meanwhile, during repeated charging and discharging, lithium secondary batteries may undergo structural deformation of the lithium metal oxide and side reactions of the electrolyte. In such cases, the lifespan characteristics of the lithium secondary battery (e.g., capacity retention) may deteriorate.

In particular, lithium secondary batteries are exposed to high-temperature environments during repeated charging and discharging, as well as overcharging. In such cases, the aforementioned issues may be accelerated, leading to battery swelling (gas generation inside the battery and an increase in battery thickness), an increase in internal resistance, and deterioration of the battery's lifespan characteristics.

### SUMMARY OF THE INVENTION

According to one aspect of the present disclosure, a lithium secondary battery with improved low-temperature storage performance and high-temperature storage performance is provided.

According to another aspect of the present disclosure, a lithium secondary battery in which delamination and detachment of a positive electrode or a negative electrode are alleviated is provided.

Meanwhile, the present disclosure can be widely applied to fields of green technology, including electric vehicles (EVs), battery charging stations, energy storage systems (ESS), and other battery-powered systems such as photovoltaics and wind power.

In addition, the present disclosure can be used in eco-friendly mobility, including electric vehicles and hybrid vehicles, which aim to prevent climate change by reducing air pollution and greenhouse gas emissions.

As a technical means to achieve the technical objects, a lithium secondary battery according to the present disclosure may comprise a positive electrode; a negative electrode; and an electrolyte comprising a lithium salt, an organic solvent, and an additive, wherein the organic solvent may comprise ethylene carbonate (EC) and propylene carbonate (PC), wherein the additive may comprise fluoroethylene carbonate (FEC), and a volume ratio of the propylene carbonate to the ethylene carbonate in the organic solvent may be 0.2 or more and less than 4.

In one embodiment, the additive may be included in an amount of 4 wt % or more and 10 wt % or less based on a total weight of the electrolyte.

In one embodiment, the organic solvent may further comprise ethyl methyl carbonate (EMC).

In one embodiment, a volume ratio of the propylene carbonate (PC) to a total volume of the ethylene carbonate (EC), the propylene carbonate (PC), and the ethyl methyl carbonate (EMC) in the organic solvent may be 0.03 or more and less than 0.2.

In one embodiment, the positive electrode may comprise a first positive electrode active material that is polycrystalline and a second positive electrode active material that is single crystalline.

In one embodiment, the positive electrode may comprise the first positive electrode active material and the second positive electrode active material in a weight ratio ranging from 3:7 to 7:3.

In one embodiment, the negative electrode may comprise a current collector, a first negative electrode active material layer comprising a first artificial graphite on the current collector, and a second negative electrode active material layer comprising a second artificial graphite on the first negative electrode active material layer.

In one embodiment, an average particle diameter of the first artificial graphite of the first negative electrode active material layer may be greater than that of the second artificial graphite of the second negative electrode active material layer.

In one embodiment, the first negative electrode active material layer and the second negative electrode active material layer may comprise at least one selected from SiC particles and SiOX particles, and surfaces of the SiC particles and the SiOX particles may comprise a carbon coating layer.

In one embodiment, the negative electrode may comprise a binder comprising at least one selected from polyacrylic acid (PAA), carboxymethyl cellulose (CMC), and styrene-butadiene rubber (SBR).

According to an embodiment of the present disclosure, low-temperature storage performance and high-temperature storage performance of the lithium secondary battery may be improved.

According to an embodiment of the present disclosure, delamination and detachment of the positive electrode or the negative electrode in the lithium secondary battery may be alleviated.

### DETAILED DESCRIPTION

The structural or functional descriptions of the embodiments disclosed in the present specification or application are merely illustrative for the purpose of explaining exemplary embodiments according to the technical spirit of the present invention. The embodiments according to the technical spirit of the present invention may be implemented in various forms other than the embodiments disclosed in the present specification or application, and the technical spirit of the present invention should not be construed as being limited to the embodiments described in the present specification or application.

According to an embodiment, the lithium secondary battery may comprise a positive electrode, a negative electrode, and an electrolyte including a lithium salt, an organic solvent, and an additive.

The lithium secondary battery may comprise the electrolyte, an electrode assembly, and a case configured to accommodate the electrolyte and the electrode assembly.

### 1. Electrolyte

An electrode assembly may be accommodated together with an electrolyte in a case to define a lithium secondary battery. According to exemplary embodiments, a non-aqueous electrolyte solution may be used as the electrolyte.

According to an embodiment, the electrolyte may comprise a lithium salt, an organic solvent, and an additive.

### Lithium Salt/Organic Solvent

The non-aqueous electrolyte solution may include a lithium salt and an organic solvent as the electrolyte. The lithium salt may be represented, for example, as Li⁺X⁻, and the anion (X⁻) of the lithium salt may include, for example, F⁻, Cl⁻, Br⁻, I⁻, NO₃⁻, N(CN)₂⁻, BF₄⁻, ClO₄⁻, PF₆⁻, (CF₃)₂ PF₄⁻, (CF₃)₃ PF₃⁻, (CF₃)₄ PF₂⁻, (CF₃)₅PF⁻, (CF₃)₆ P⁻, CF₃SO₃⁻, CF₃CF₂SO₃⁻(CF₃SO₂)₂N⁻, (FSO₂)₂N⁻, CF₃CF₂(CF₃)₂C⁻, (CF₃SO₂)₂CH⁻, (SF₅)₃C⁻, (CF₃SO₂)₃C⁻, CF₃(CF₂)₇SO₃⁻, CF₃CO₂, CH₃CO₂⁻, SCN⁻, and (CF₃CF₂SO₂)₂N⁻.

The organic solvent may comprise organic compounds that have sufficient solubility for the lithium salt and the additive, and are non-reactive inside the battery.

According to an embodiment, the organic solvent may comprise a carbonate-based solvent.

According to an embodiment, the organic solvent may comprise ethylene carbonate (EC) and propylene carbonate (PC).

Electrolytes used in conventional lithium secondary batteries primarily include ethylene carbonate (EC)-based solvents (either ethylene carbonate alone or a mixture of ethylene carbonate and other carbonate-based solvents such as ethyl methyl carbonate (EMC), dimethyl carbonate (DMC), diethyl carbonate (DEC), or at least two or more of these). In such cases, the lithium secondary battery may exhibit a significant decrease in performance under low-temperature conditions. Furthermore, ethylene carbonate tends to generate gas more easily during high-temperature storage, which may result in inferior high-temperature storage performance of the lithium secondary battery comprising such an electrolyte composition.

According to an embodiment, as described above, the electrolyte of the present disclosure may comprise ethylene carbonate and propylene carbonate as the organic solvent. That is, to minimize gas generation caused by ethylene carbonate as mentioned above, a portion of the ethylene carbonate content in the organic solvent of the present disclosure may be replaced with propylene carbonate.

Meanwhile, according to an embodiment, a volume ratio of the propylene carbonate to the ethylene carbonate in the organic solvent may be 0.2 or more and less than 4. In other words, according to an embodiment, the volumes of ethylene carbonate and propylene carbonate in the organic solvent may satisfy the following Equation 1:

$$0.2 \leq {V}_{PC} / {V}_{EC} < 4 \qquad [ Equation 1 ]$$

In Equation 1, V_{PC} is the volume of the propylene carbonate in the organic solvent, and V_{EC} is the volume of the ethylene carbonate in the organic solvent.

As will be described below, in the lithium secondary battery of the present disclosure, which may include graphite-based carbon as at least one component of the negative electrode active material, when propylene carbonate is included in the electrolyte in an amount exceeding a necessary level, the propylene carbonate may penetrate into the graphite and, as a result, cause delamination and/or detachment of the negative electrode active material layer.

Therefore, by adjusting the volume ratio of the propylene carbonate to the ethylene carbonate in the organic solvent, battery performance under low-temperature conditions can be improved, and gas generation during high-temperature storage can be alleviated. In addition, by adjusting the volume ratio of ethylene carbonate to propylene carbonate, delamination and/or detachment caused by penetration of the organic solvent into the graphite can be alleviated.

A lithium secondary battery including an electrolyte comprising ethylene carbonate (EC) and propylene carbonate (PC) in a specific volume ratio, as in the present disclosure, may reduce the amount of gas generation.

A lithium secondary battery including an electrolyte comprising ethylene carbonate (EC) and propylene carbonate (PC) in a specific volume ratio, as in the present disclosure, may improve capacity retention at high temperatures.

According to an embodiment, the organic solvent may further comprise ethyl methyl carbonate (EMC). That is, according to an embodiment, the organic solvent may comprise ethylene carbonate, propylene carbonate, and ethyl methyl carbonate.

According to an embodiment, a volume ratio of the propylene carbonate (PC) to a total volume of the ethylene carbonate (EC), the propylene carbonate (PC), and the ethyl methyl carbonate (EMC) in the organic solvent may be 0.03 or more and less than 0.2. That is, according to an embodiment, the volume of the propylene carbonate in the organic solvent may satisfy the following Equation 2:

$$0.03 \leq {V}_{PC} / ( {V}_{EC} + {V}_{PC} + {V}_{EMC} ) < 0.2 \qquad [ Equation 2 ]$$

In Equation 2, V_{PC} is the volume of the propylene carbonate in the organic solvent, V_{EC} is the volume of the ethylene carbonate in the organic solvent, and V_{EMC} is the volume of the ethyl methyl carbonate in the organic solvent.

As will be described below, in the lithium secondary battery of the present disclosure, which may include graphite-based carbon as at least one component of the negative electrode active material, adjusting the volume ratio of ethylene carbonate (EC), propylene carbonate (PC), and ethyl methyl carbonate (EMC) in the organic solvent to a specific range, as in the present disclosure, may further improve battery performance under low-temperature conditions and further alleviate gas generation during high-temperature storage. In addition, delamination and/or detachment caused by penetration of the organic solvent into the graphite may be further alleviated.

Meanwhile, according to an exemplary embodiment, if necessary, the organic solvent may further comprise at least one selected from carbonate-based solvents, ester-based solvents, ether-based solvents, ketone-based solvents, alcohol-based solvents, and aprotic solvents, in addition to ethylene carbonate, propylene carbonate, and ethyl methyl carbonate. Examples thereof may include butylene carbonate, diethyl carbonate (DEC), dimethyl carbonate (DMC), methylpropyl carbonate, ethylpropyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), and 2-methyltetrahydrofuran, ethyl alcohol, isopropyl alcohol, dimethyl sulfoxide, acetonitrile, dimethoxyethane, diethoxyethane, sulfolane, gamma-butyrolactone, and propylene sulfite. These may be included alone or in combination of two or more.

### Additive

The non-aqueous electrolyte solution may further comprise an additive. According to an embodiment, the additive may comprise fluoroethylene carbonate (FEC).

A lithium secondary battery comprising an additive including fluoroethylene carbonate may suppress internal side reactions, reduce charging resistance, and thereby improve charging efficiency and output. In addition, a lithium secondary battery comprising an additive including fluoroethylene carbonate may exhibit improved high-temperature capacity retention.

According to an embodiment, the additive may be included in an amount of 4 wt % or more and 10 wt % or less based on a total weight of the electrolyte.

Meanwhile, if necessary, the additive may further comprise additional additives in addition to the fluoroethylene carbonate. For example, the additive may further comprise cyclic carbonate-based compounds, fluorine-substituted carbonate-based compounds, sultone-based compounds, cyclic sulfate-based compounds, cyclic sulfite-based compounds, phosphate-based compounds, and borate-based compounds.

The cyclic carbonate-based compounds may include, for example, vinylene carbonate (VC) and vinyl ethylene carbonate (VEC).

The sultone-based compounds may include, for example, 1,3-propane sultone, 1,3-propene sultone, and 1,4-butane sultone.

The cyclic sulfate-based compounds may include, for example, 1,2-ethylene sulfate and 1,2-propylene sulfate.

The cyclic sulfite-based compounds may include, for example, ethylene sulfite and butylene sulfite.

The phosphate-based compounds may include, for example, lithium difluoro bis-oxalato phosphate and lithium difluoro phosphate.

The borate-based compounds may include, for example, lithium bis(oxalate) borate.

### 2. Positive Electrode

The positive electrode may comprise a positive electrode current collector and a positive electrode active material layer disposed on at least one surface of the positive electrode current collector.

### Positive Electrode Current Collector

The positive electrode current collector may comprise stainless steel, nickel, aluminum, titanium, or an alloy thereof. The positive electrode current collector may also comprise aluminum or stainless steel surface-treated with carbon, nickel, titanium, or silver. For example, the positive electrode current collector may have a thickness of 10 to 50 μm. However, the embodiment is not limited thereto.

### Positive Electrode Active Material

The positive electrode active material layer may comprise a positive electrode active material. The positive electrode active material may comprise a compound capable of reversibly intercalating and deintercalating lithium ions.

According to an embodiment, the positive electrode may comprise a first positive electrode active material that is polycrystalline and a second positive electrode active material that is single crystalline. That is, the positive electrode may comprise the first positive electrode active material and the second positive electrode active material as the positive electrode active material.

For example, the single-crystalline and polycrystalline structures may be distinguished based on ion images obtained by analyzing particle cross-sections using a focused ion beam (FIB). For instance, if a particle has a polycrystalline structure, two or more single crystals may be observed in the FIB image due to differences in crystal orientation. Even if a particle appears as a single particle in an SEM cross-sectional image, it may be observed as a particle composed of two or more crystals in the FIB image.

According to an embodiment, the first positive electrode active material and the second positive electrode active material may be included in the positive electrode in a weight ratio ranging from 3:7 to 7:3.

That is, the positive electrode active material of the present disclosure may comprise the first positive electrode active material that is polycrystalline and the second positive electrode active material that is single crystalline in a specific composition ratio. When the positive electrode active material comprises the first positive electrode active material and the second positive electrode active material in such a specific composition ratio as in the present disclosure, the high-temperature stability of the battery can be further improved.

According to exemplary embodiments, at least one of the first positive electrode active material and the second positive electrode active material may comprise a lithium-nickel metal oxide. The lithium-nickel metal oxide may further comprise at least one of cobalt (Co), manganese (Mn), and aluminum (AI).

In some embodiments, the lithium-nickel metal oxide may have a layered structure or crystal structure represented by the following Chemical Formula 1:

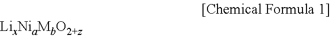

In Chemical Formula 1, 0.9≤x≤1.2, 0.6≤a≤0.99, 0.01≤b≤0.4, −0.5≤z≤0.1. As described above, M may comprise Co, Mn, and/or Al.

The chemical structure represented by Chemical Formula 1 indicates bonding relationships within the layered structure or crystal structure of the positive electrode active material and does not exclude the presence of other additional elements. For example, M may comprise Co and/or Mn, and Co and/or Mn may serve as main active elements in the positive electrode active material along with Ni. Chemical Formula 1 is intended to illustrate the bonding relationships of the main active elements and should be understood to encompass introduction and substitution of additional elements.

In one embodiment, auxiliary elements may be further included to enhance the chemical stability of the positive electrode active material or the layered/crystal structure in addition to the main active elements. The auxiliary elements may be incorporated and bonded within the layered/crystal structure, and such cases should also be understood to fall within the scope of the chemical structure represented by Chemical Formula 1.

The auxiliary elements may comprise at least one selected from Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. For example, the auxiliary element may act as an auxiliary active element contributing to the capacity/output activity of the positive electrode active material, such as Al when used together with Co or Mn.

For example, the lithium-nickel metal oxide may comprise a layered structure or crystal structure represented by the following Chemical Formula 1-1:

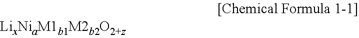

In Chemical Formula 1-1, M1 may comprise Co, Mn, and/or Al, and M2 may comprise one or more of the aforementioned auxiliary elements. In Chemical Formula 1-1, 0.9≤x≤1.2, 0.6≤a≤0.99, 0.01≤b1+b2≤0.4, −0.5≤z≤0.1.

At least one of the first positive electrode active material and the second positive electrode active material may further comprise a coating element or a doping element. For example, elements that are substantially the same as or similar to the above-described auxiliary elements may be used as the coating element or doping element. These elements may be used individually or in combination of two or more.

The coating element or doping element may exist on the surface of the lithium-nickel metal oxide particle, or may penetrate through the surface of the lithium-nickel metal composite oxide particle and be incorporated into the bonding structure represented by Chemical Formula 1 or Chemical Formula 1-1.

At least one of the first positive electrode active material and the second positive electrode active material may comprise a nickel-cobalt-manganese (NCM)-based lithium oxide. In this case, an NCM-based lithium oxide with an increased nickel content may be used.

Ni may serve as a transition metal related to the output and capacity of the lithium secondary battery. Accordingly, by adopting a high-Ni composition in the positive electrode active material as described above, a high-capacity positive electrode and a high-capacity lithium secondary battery can be provided.

However, as the Ni content increases, long-term storage stability and lifespan stability of the positive electrode or the lithium secondary battery may deteriorate, and side reactions with the electrolyte may increase. However, according to exemplary embodiments, by including Co to maintain electrical conductivity and Mn to enhance lifespan stability and capacity retention characteristics, such degradation may be mitigated.

The content of Ni in the NCM-based lithium oxide (e.g., the molar fraction of nickel in the total number of moles of nickel, cobalt, and manganese) may be 0.6 or more, 0.7 or more, or 0.8 or more. The content of Ni may be less than 1. In some embodiments, the content of Ni may be 0.8 or more, 0.82 or more, 0.83 or more, 0.84 or more, 0.85 or more, 0.86 or more, or 0.87 or more, and may be 0.95 or less, 0.96 or less, 0.97 or less, 0.98 or less, or 0.99 or less.

In some embodiments, at least one of the first positive electrode active material and the second positive electrode active material may further comprise a lithium cobalt oxide-based active material, a lithium manganese oxide-based active material, a lithium nickel oxide-based active material, or a lithium iron phosphate (LFP)-based active material (e.g., LiFePO₄).

In some embodiments, at least one of the first positive electrode active material and the second positive electrode active material may comprise, for example, an Mn-rich-based active material, an LLO (Li-rich layered oxide)/OLO (Over-Lithiated Oxide)-based active material, or a Co-less-based active material having a chemical structure or crystal structure represented by the following Chemical Formula 2:

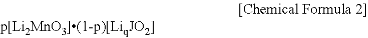

In Chemical Formula 2, 0<p<1, 0.9≤q≤1.2, and J may comprise at least one element selected from Mn, Ni, Co, Fe, Cr, V, Cu, Zn, Ti, Al, Mg, and B.

### Manufacturing Method of the Positive Electrode

For example, a positive electrode slurry may be prepared by mixing the above-described positive electrode active material in a solvent. The positive electrode slurry may then be coated onto a positive electrode current collector, followed by drying and rolling to form a positive electrode active material layer. The coating process may be carried out using methods such as gravure coating, slot die coating, multilayer simultaneous die coating, imprinting, doctor blade coating, dip coating, bar coating, and casting, but is not limited thereto. The positive electrode active material layer may further comprise a binder and may optionally comprise a conductive material, a thickener, and the like.

### Positive Electrode Solvent

Non-limiting examples of solvents used for preparing the positive electrode active material include N-methyl-2-pyrrolidone (NMP), dimethylformamide, dimethylacetamide, N,N-dimethylaminopropylamine, ethylene oxide, and tetrahydrofuran.

### Positive Electrode Binder

The binder may comprise polyvinylidene fluoride (PVDF), poly(vinylidene fluoride-co-hexafluoropropylene), polyacrylonitrile, polymethylmethacrylate, acrylonitrile-butadiene rubber (NBR), polybutadiene rubber (BR), and styrene-butadiene rubber (SBR). In one embodiment, a PVDF-based binder may be used as the positive electrode binder.

### Positive Electrode Conductive Material

The conductive material may be added to enhance the conductivity of the positive electrode active material layer and/or the mobility of lithium ions or electrons. For example, the conductive material may include carbon-based conductive materials such as graphite, carbon black, acetylene black, Ketjen black, graphene, carbon nanotubes, vapor-grown carbon fiber (VGCF), and carbon fiber, and/or metal-based conductive materials such as tin, tin oxide, titanium oxide, LaSrCoO₃, and LaSrMnO₃, which are perovskite materials, but is not limited thereto.

### Positive Electrode Thickener/Dispersant

If necessary, the positive electrode active material may further comprise a thickener and/or a dispersant. In one embodiment, the positive electrode active material may comprise a thickener such as carboxymethyl cellulose (CMC).

### 3. Negative Electrode

The negative electrode may comprise a negative electrode current collector and a negative electrode active material layer disposed on at least one surface of the negative electrode current collector.

### Negative Electrode Current Collector

Non-limiting examples of the negative electrode current collector include copper foil, nickel foil, stainless steel foil, titanium foil, nickel foam, copper foam, and polymer substrates coated with a conductive metal. For example, the thickness of the negative electrode current collector may be 10 to 50 μm, but is not limited thereto.

### Negative Electrode Active Material

The negative electrode active material layer may comprise a negative electrode active material. The negative electrode active material may be a material capable of adsorbing and desorbing lithium ions. Examples of the negative electrode active material include carbon-based materials such as crystalline carbon, amorphous carbon, carbon composites, and carbon fibers; lithium metal; lithium alloys; silicon (Si)-containing materials; and tin (Sn)-containing materials.

Examples of the amorphous carbon include hard carbon, soft carbon, coke, mesocarbon microbeads (MCMB), and mesophase pitch-based carbon fiber (MPCF).

Examples of the crystalline carbon include graphite-based carbon such as natural graphite, artificial graphite, graphitized coke, graphitized MCMB, and graphitized MPCF.

The lithium metal may be pure lithium metal or lithium metal having a protective layer for inhibiting dendrite growth. In one embodiment, a lithium metal-containing layer deposited or coated on a current collector may be used as the negative electrode active material layer. In another embodiment, a lithium thin film layer may be used as the negative electrode active material layer.

Examples of elements included in the lithium alloy may include aluminum, zinc, bismuth, cadmium, antimony, silicon, lead, tin, gallium, or indium.

The silicon-containing material may provide enhanced capacity characteristics. The silicon-containing material may include Si, SiOₓ (0<x<2), metal-doped SiOₓ (0<x<2), and silicon-carbon composites. The metal may include lithium and/or magnesium, and the metal-doped SiOₓ (0<x<2) may include a metal silicate.

According to an embodiment, the negative electrode may comprise a current collector, a first negative electrode active material layer comprising a first artificial graphite on the current collector, and a second negative electrode active material layer comprising a second artificial graphite on the first negative electrode active material layer.

According to an embodiment, an average particle diameter of the first artificial graphite in the first negative electrode active material layer may be greater than that of the second artificial graphite in the second negative electrode active material layer.

According to an embodiment, the first negative electrode active material layer and the second negative electrode active material layer may comprise at least one of SiC particles and SiOₓ particles, and surfaces of the SiC particles and the SiOₓ particles may comprise a carbon coating layer.

In such embodiments, battery performance may be further improved. Meanwhile, as described above, by including an electrolyte comprising ethylene carbonate and propylene carbonate in a specific volume ratio, or an electrolyte comprising ethylene carbonate, propylene carbonate, and ethyl methyl carbonate in a specific volume ratio, delamination and/or detachment caused by penetration of the organic solvent into the graphite can be minimized, while battery performance under low-temperature conditions can be further improved, and gas generation during high-temperature storage can be further alleviated.

### Manufacturing Method of the Negative Electrode

For example, a negative electrode slurry may be prepared by mixing the negative electrode active material in a solvent. The negative electrode slurry may be coated or deposited onto the negative electrode current collector, followed by drying and rolling, to form the negative electrode active material layer. Alternatively, a negative electrode slurry (having the same or different composition) may be applied again onto the previously formed negative electrode active material layer, followed by drying and rolling, to form a multilayer negative electrode active material layer. The coating process may be carried out using methods such as gravure coating, slot die coating, multilayer simultaneous die coating, imprinting, doctor blade coating, dip coating, bar coating, and casting, but is not limited thereto. The negative electrode active material layer may further comprise a binder and may optionally comprise a conductive material, a thickener, and the like.

In some embodiments, the negative electrode may include a negative electrode active material layer formed in the form of lithium metal through a deposition/coating process.

### Negative Electrode Solvent

Non-limiting examples of solvents for the negative electrode active material include water, pure water, deionized water, distilled water, ethanol, isopropanol, methanol, acetone, n-propanol, and t-butanol.

### Negative Electrode Binder/Conductive Material/Thickener

The binder, conductive material, and thickener used for the positive electrode may also be used for the negative electrode.

In some embodiments, the negative electrode binder may comprise a styrene-butadiene rubber (SBR)-based binder, carboxymethyl cellulose (CMC), a polyacrylic acid (PAA)-based binder, or a poly(3,4-ethylenedioxythiophene) (PEDOT)-based binder.

According to an embodiment, the negative electrode may comprise a binder comprising at least one selected from polyacrylic acid (PAA), carboxymethyl cellulose (CMC), and styrene-butadiene rubber (SBR).

### 4. Separator

A separator may be interposed between the positive electrode and the negative electrode. The separator may be configured to prevent electrical short-circuiting between the positive electrode and the negative electrode, while allowing the flow of ions. According to an embodiment, the thickness of the separator may be 10 μm to 20 μm; however, the present disclosure is not limited thereto.

For example, the separator may comprise a porous polymer film or a porous nonwoven fabric. The porous polymer film may comprise a polyolefin-based polymer such as an ethylene polymer, a propylene polymer, an ethylene/butene copolymer, an ethylene/hexene copolymer, or an ethylene/methacrylate copolymer. The porous nonwoven fabric may comprise high-melting-point glass fibers or polyethylene terephthalate fibers. The separator may also include a ceramic-based material. For example, inorganic particles may be coated on the polymer film or dispersed within the polymer film to improve heat resistance.

The separator may have a single-layer or multilayer structure comprising the above-described polymer film and/or nonwoven fabric.

### 5. Electrode Assembly

According to exemplary embodiments, an electrode assembly may be formed by repeatedly stacking a positive electrode, a negative electrode, and a separator. In some embodiments, the electrode assembly may have a winding type, a stacking type, a zigzag folding (z-folding) type, or a stack-folding type.

Hereinafter, the present disclosure will be described in more detail based on embodiments and comparative examples. However, the following embodiments and comparative examples are merely illustrative for explaining the present disclosure in further detail, and the present disclosure is not limited to these embodiments and comparative examples.

In addition, each compound is denoted as follows:
Propylene carbonate: PC
Ethylene carbonate: EC
Ethyl methyl carbonate: EMC
Lithium hexafluorophosphate: LiPF₆
Fluoroethylene carbonate: FEC

### 6. Embodiments, Comparative Examples, and Experimental Examples

### (1) Electrolyte Embodiment and Comparative Example

### Example 1

### 1) Electrolyte Preparation

A non-aqueous electrolyte according to Embodiment 1 was prepared by dissolving 1.1 M of LiPF₆ in a mixed solvent of EC/PC/EMC (20:5:75 by volume %) and mixing 5 wt % of FEC as an additive.

### 2) Lithium Secondary Battery Fabrication

A positive electrode slurry was prepared by dispersing a positive electrode active material of Li[Ni_{0.88}Co_{0.06}Mn_{0.06}]O₂, carbon black, and polyvinylidene fluoride (PVDF) in NMP at a weight ratio of 98:1:1. The positive electrode slurry was uniformly coated onto aluminum foil with a thickness of 12 μm, followed by drying and rolling to form a positive electrode.

A first negative electrode slurry was prepared by dispersing SiOₓ (0≤x≤30) particles as silicon-based compounds, artificial graphite, a conductive material (SWCNT), styrene-butadiene rubber (SBR), and carboxymethyl cellulose (CMC) in water at a weight ratio of 26:71.9:0.2:0.6:1.3. A second negative electrode slurry was prepared by dispersing SiOₓ (0<x<10) particles, artificial graphite, a conductive material (SWCNT), SBR, and CMC in water at a weight ratio of 86.1:10.0:0.2:2.4:1.3. The first negative electrode slurry was uniformly coated onto copper foil with a thickness of 8 μm, and then the second negative electrode slurry was sequentially coated, followed by drying and rolling to prepare the negative electrode.

A polyethylene (PE) film separator with a thickness of 13 μm was stacked between the fabricated electrodes. A cell was assembled using a pouch with dimensions of 13 mm (thickness)×110 mm (width)×300 mm (length), and the electrolyte prepared in step 1) was injected to fabricate a lithium secondary battery.

### Example 2

Except that a mixed solvent of EC/PC/EMC (15:10:75 by volume %) was used for

electrolyte preparation, the electrolyte and lithium secondary battery were fabricated in the same manner as in Example 1.

### Example 3

Except that a mixed solvent of EC/PC/EMC (10:15:75 by volume %) was used for electrolyte preparation, the electrolyte and lithium secondary battery were fabricated in the same manner as in Example 1.

### Comparative Example 1

Except that a mixed solvent of EC/PC/EMC (25:0:75 by volume %) was used for electrolyte preparation, the electrolyte and lithium secondary battery were fabricated in the same manner as in Example 1.

### Comparative Example 2

Except that a mixed solvent of EC/PC/EMC (5:20:75 by volume %) was used for electrolyte preparation, the electrolyte and lithium secondary battery were fabricated in the same manner as in Example 1.

The compositions of the electrolytes prepared according to the Examples and comparative examples are as follows:

TABLE 1

| | Solvent (vol %) | | | Additive (wt %) | Salt (M) |
|---|---|---|---|---|---|
| | EC | PC | EMC | FEC | LiPF₆ |
| Example 1 | 20 | 5 | 75 | 5 | 1.1 |
| Example 2 | 15 | 10 | 75 | 5 | 1.1 |
| Example 3 | 10 | 15 | 75 | 5 | 1.1 |
| Comparative Example 1 | 25 | 0 | 75 | 5 | 1.1 |
| Comparative Example 2 | 5 | 20 | 75 | 5 | 1.1 |

### (2) Experimental Example 1—High-Temperature Storage Characteristics

For the lithium secondary batteries comprising the electrolytes prepared according to Examples 1 to 3 and Comparative Examples 1 and 2, the batteries were left for 20 weeks under exposure conditions at 60° C. using a constant-temperature chamber. After the storage period, the remaining sealing length at room temperature was measured using a ruler. The “remaining sealing length” refers to the length of the sealing portion after it has been displaced due to gas generation from the battery. The initial sealing length, i.e., the length of the sealing portion before any displacement occurred, was approximately 5.5 mm.

TABLE 2

| | Remaining Sealing Length (mm) |
|---|---|
| Example 1 | 1.0 |
| Example 2 | 3.5 |
| Example 3 | 4.0 |
| Comparative Example 1 | 0, Venting |
| Comparative Example 2 | Not measurable |

Referring to Table 2, the lithium secondary batteries of Examples 1 to 3 retained sealing portions of 1.0 mm, 3.5 mm, and 4.0 mm, respectively, even after high-temperature storage. In contrast, in Comparative Example 1, the entire sealing portion was displaced due to gas generation from the battery, resulting in a measured remaining sealing length of 0 mm. Meanwhile, in Comparative Example 2, evaluation could not be conducted due to delamination and detachment of the artificial graphite caused by the excessive amount of PC solvent.

Accordingly, it was confirmed that the high-temperature storage performance of Examples 1 to 3, in which the electrolyte composition falls within the range defined by the present disclosure, is superior to that of Comparative Examples 1 and 2.

### (3) Positive Electrode Active Material Example and Comparative Example

### Example 4

### 1) Preparation of Positive Electrode Active Material

A positive electrode active material according to Example 4 was prepared by mixing polycrystalline lithium metal oxide particles (Li[Ni_{0.88}Co_{0.06}Mn_{0.06}]O₂) and single-crystalline lithium metal oxide particles (Li[Ni_{0.88}Co_{0.06}Mn_{0.06}]O₂) at a weight ratio of 60:40.

### 2) Fabrication of Lithium Secondary Battery

A positive electrode slurry was prepared by dispersing the positive electrode active material prepared in step 1), carbon black, and polyvinylidene fluoride (PVDF) in NMP at a weight ratio of 98:1:1. The positive electrode slurry was uniformly coated onto aluminum foil with a thickness of 12 μm, followed by drying and rolling to prepare the positive electrode. A first negative electrode slurry was prepared by dispersing SiOₓ (0≤x≤30) particles

as silicon-based compounds, artificial graphite, a conductive material (SWCNT), styrene-butadiene rubber (SBR), and carboxymethyl cellulose (CMC) in water at a weight ratio of 26:71.9:0.2:0.6:1.3. A second negative electrode slurry was prepared by dispersing SiOₓ (0<x<10) particles, artificial graphite, a conductive material (SWCNT), SBR, and CMC in water at a weight ratio of 86.1:10.0:0.2:2.4:1.3. The first negative electrode slurry was uniformly coated onto copper foil with a thickness of 8 μm, followed by sequential coating of the second negative electrode slurry, drying, and rolling to prepare the negative electrode.

A non-aqueous electrolyte was prepared by dissolving 1.1 M of LiPF₆ in a mixed solvent of EC/PC/EMC (10:15:75 by volume %) and mixing 5 wt % of FEC as an additive.

A polyethylene (PE) film separator with a thickness of 13 μm was stacked between the fabricated electrodes. A cell was assembled using a pouch with dimensions of 13 mm (thickness)×110 mm (width)×300 mm (length), and the prepared electrolyte was injected to fabricate a lithium secondary battery.

### Example 5

Except that the positive electrode active material was prepared by mixing polycrystalline lithium metal oxide particles (Li[Ni_{0.88}Co_{0.06}Mn_{0.06}]O₂) and single-crystalline lithium metal oxide particles (Li[Ni_{0.88}Co_{0.06}Mn_{0.06}]O₂) at a weight ratio of 50:50, the positive electrode active material and lithium secondary battery were fabricated in the same manner as in Example 4.

### Example 6

Except that the positive electrode active material was prepared by mixing polycrystalline lithium metal oxide particles (Li[Ni_{0.88}Co_{0.06}Mn_{0.06}]O₂) and single-crystalline lithium metal oxide particles (Li[Ni_{0.88}Co_{0.06}Mn_{0.06}]O₂) at a weight ratio of 100:0, the positive electrode active material and lithium secondary battery were fabricated in the same manner as in Example 4.

### (4) Experimental Example 2—High-Temperature Storage Characteristics

For the lithium secondary batteries comprising the positive electrode active materials prepared in Examples 4 to 6, the batteries were stored under exposure conditions at 60° C. for 20 weeks using a constant-temperature chamber. After the storage period, the remaining sealing length at room temperature was measured. The definition and measurement method of the remaining sealing length are the same as those described in Experimental Example 1.

TABLE 3

| | Remaining Sealing Length (mm) |
|---|---|
| Example 4 | 4.0 |
| Example 5 | 3.5 |
| Example 6 | 1 to 2 |

Referring to Table 3, it was confirmed that all lithium secondary batteries of Examples 4 to 6, in which the electrolyte composition satisfies the range defined by the present disclosure, retained sealing portions even under high-temperature storage conditions, indicating excellent high-temperature storage performance. However, while the lithium secondary batteries of Examples 4 and 5 retained sealing portions of 4.0 mm and 3.5 mm, respectively, after high-temperature storage, the lithium secondary battery of Example 6 retained only about 1.0 to 2.0 mm. Accordingly, it was confirmed that the high-temperature storage performance of Examples 4 and 5, which include both polycrystalline and single-crystalline positive electrode active materials within the range defined by the present disclosure, is superior to that of Example 6, which includes only polycrystalline positive electrode active material.

The present disclosure may be embodied in various forms, and the scope of rights should not be limited to the above-described embodiments. Therefore, if a modified embodiment includes the components of the present disclosure, it should be considered to fall within the scope of the present disclosure.

What is claimed is:

1. A lithium secondary battery comprising:
a positive electrode;
a negative electrode; and
an electrolyte comprising a lithium salt, an organic solvent, and an additive,
wherein the organic solvent comprises ethylene carbonate (EC) and propylene carbonate (PC),
wherein the additive comprises fluoroethylene carbonate (FEC), and
wherein a volume ratio of the propylene carbonate to the ethylene carbonate in the organic solvent is 0.2 or more and less than 4.

2. The lithium secondary battery according to claim 1, wherein the additive is included in an amount of 4 wt % or more and 10 wt % or less based on a total weight of the electrolyte.

3. The lithium secondary battery according to claim 1, wherein the organic solvent further comprises ethyl methyl carbonate (EMC).

4. The lithium secondary battery according to claim 3, wherein a volume ratio of the propylene carbonate (PC) to a total volume of the ethylene carbonate (EC), the propylene carbonate (PC), and the ethyl methyl carbonate (EMC) in the organic solvent is 0.03 or more and less than 0.2.

5. The lithium secondary battery according to claim 1, wherein the positive electrode comprises a first positive electrode active material that is polycrystalline and a second positive electrode active material that is single crystalline.

6. The lithium secondary battery according to claim 5, wherein the positive electrode comprises the first positive electrode active material and the second positive electrode active material in a weight ratio ranging from 3:7 to 7:3.

7. The lithium secondary battery according to claim 1, wherein the negative electrode comprises
a current collector,
a first negative electrode active material layer comprising a first artificial graphite on the current collector, and
a second negative electrode active material layer comprising a second artificial graphite on the first negative electrode active material layer.

8. The lithium secondary battery according to claim 7, wherein an average particle diameter of the first artificial graphite of the first negative electrode active material layer is greater than that of the second artificial graphite of the second negative electrode active material layer.

9. The lithium secondary battery according to claim 7, wherein the first negative electrode active material layer and the second negative electrode active material layer comprise at least one selected from SiC particles and SiO_{X} particles, and surfaces of the SiC particles and the SiO_{X} particles comprise a carbon coating layer.

10. The lithium secondary battery according to claim 1, wherein the negative electrode comprises a binder comprising at least one selected from polyacrylic acid (PAA), carboxymethyl cellulose (CMC), and styrene-butadiene rubber (SBR).
